(19) United States
(12) Patent Application Publication
(10) Pub. No.: US 2004/0203567 A1
(43) Pub. Date: Oct. 14, 2004

(54) Apparatus and method for providing emergency information in a signpost location system

(76) Inventor: Jeffrey Berger, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/302,403

(22) Filed: Nov. 22, 2002

(51) Int. Cl. H04M 11/00; H04Q 7/20

(52) U.S. Cl. 455/404.1; 455/456.1

(57) ABSTRACT

A wireless communication device (120) and a cooperative apparatus for placing emergency calls to a local responding agency (122) are provided. The device (120) comprises a receiving circuit (404) that receives location information (202, 204) and contact information (206) from a beacon (102, 104, 106) and a processor (408) that places a call based on the contact information in response to detecting a user activation at a user interface (414). The location information (202, 204) corresponds to a location of the beacon (102, 104, 106), and the contact information (206) is associated with the local responding agency (122).

### FIELD OF THE INVENTION

The present invention relates generally to the field of signpost location systems for in-building, campus, transportation facilities, sports/entertainment venues and other defined spaces.

### BACKGROUND OF THE INVENTION

Signpost location systems are in public use in various forms. Many signpost location systems are “beacon-type” systems that broadcast a continuous signal over RF, infrared or ultrasound and contain information about an individual beacon's identity. A mobile device passing through beacon signals updates its internal information with beacon ID numbers. In the event of an incident, the mobile device is activated and sends a signal to a base station that includes the mobile device ID and the current beacon ID. By lookup, the system determines the location of the mobile device from the beacon ID. Common implementations of such systems are used in building where GPS location information is not available or on large campuses.

In response to receiving an emergency signal, the system calls a general emergency number, such as 911 in the U.S. or 112 in other GSM environments, associated with the location of the mobile device. Although general emergency numbers may be appropriate in some cases, they may not be the most appropriate number to call in other situations, as in the case of an airport with its own response authorities. Also, the appropriate emergency number or response web site to contact in the event of an emergency is not typically apparent to the user of the mobile device. Thus, there is a need for an apparatus and method for providing to a system more precise and/or customized information about an appropriate responding agency for a particular local area.

### BRIEF DESCRIPTION OF THE DRAWINGS

FIG. 1 is a perspective view of a preferred embodiment in accordance with the present invention, which includes a plurality of beacons, a mobile device and a responding agency.

FIG. 2 is a block diagram representing an exemplary data packet that may be communicated between the beacons and the mobile device of FIG. 1.

FIG. 3 is a block diagram representing subcomponents of each beacon of FIG. 1.

FIG. 4 is a block diagram representing subcomponents of the mobile device of FIG. 1.

FIG. 5 is a block diagram representing subcomponents of the responding agency of FIG. 1.

FIG. 6 is a flow diagram representing a preferred operation of the mobile device of FIG. 4.

### DETAILED DESCRIPTION OF THE PREFERRED EMBODIMENT

The present invention is an apparatus, including a mobile device, and method capable of receiving beacon signals and broadcasting alert/alarm information over wireless communication networks, such as public carrier networks. The apparatus and method provides more precise and/or customized information about an appropriate responding agency for a particular local area to a base station or other equipment of a communication network. In particular, additional contact information associated with an appropriate responding agency for a particular local area is embedded in the beacon signal of a signpost location system. Emergency response information, including the additional contact information, is transferred to a mobile device so that the mobile device may contact a responding agency in the event that an emergency function of the mobile device is activated.

The present invention is a wireless communication device for placing emergency calls to a local responding agency. The device comprises a receiving circuit and a processor coupled to the receiving circuit. The receiving circuit receives location information and contact information from a beacon in which the location information corresponds to a location of the beacon. The processor places a call based on the contact information in response to detecting a user activation.

The present invention is also an apparatus for assisting a wireless communication device to place emergency calls to a local responding agency. The apparatus comprises a beacon located within a local area. The beacon transmits location information corresponding to the local area and contact information associated with the local responding agency.

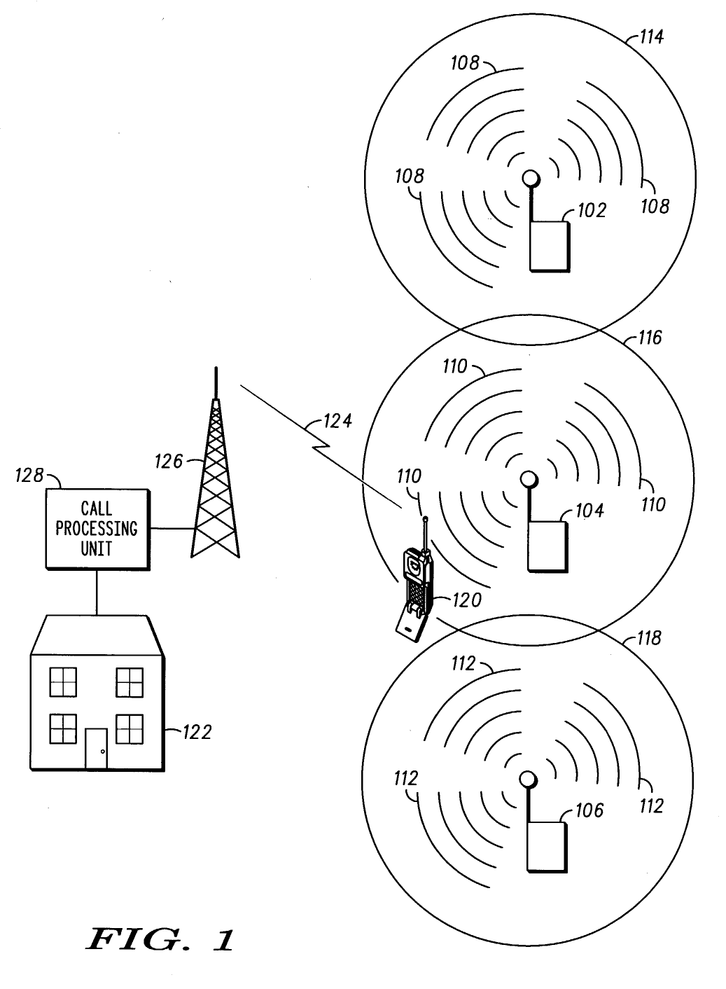

Referring to FIG. 1, there is shown a signpost location system 100 in accordance with a preferred embodiment of the present invention. The signpost location system comprises a plurality of signpost or beacons 102, 104, 106 in which each beacon continuously broadcasts a beacon signal via a short-range wireless link 108, 110, 112 over a corresponding, limited geographic coverage areas 114, 116, 118.

A mobile device 120 may travel through the coverage areas 114, 116, 118 of one or more beacons 102, 104, 106. The mobile device 120 is equipped with circuitry to receive beacon signals via the short-range wireless link 108, 110, 112. This same circuitry, or additional circuitry, of the mobile device 120 communicates with a responding agency 122 via a longer-range wireless link 124. For the preferred embodiment, the short-range wireless link 108, 110, 112 is an ad hoc, peer-to-peer connection whereas the long-range wireless link 124 is a cellular network connection for communication from one device to another via a cellular infrastructure.

Examples of the mobile device 120 include, but are not limited to, radiotelephones, paging devices, personal digital assistants, portable computing devices, and the like, having wireless communication capabilities. Examples of short-range wireless links 108, 110, 112 include, but are not limited to, Bluetooth, Wi-Fi (i.e., IEEE 802.11a, 802.11b and 802.11g), HomeRF, proprietary RF communications, and infrared communications. The longer-range wireless link 124 may utilize standard protocols including, but are not limited to, analog, CDMA, GSM, TDMA, UMTS, and paging protocols such as FLEX and REFLEX.

The beacons 102, 104, 106 and associated antenna (if required) are systematically placed around a campus, building or other space that is served by the responding agency 122. For the preferred embodiment, the beacons 102, 104, 106 are situated so that one or more receivable signals are available at every location within the area served by the responding agency 122. As shown by example in FIG. 1, overlapping coverage areas 114, 116, 118 may be necessary in order to ensure full coverage within the served area. The transmission signal strength of the beacons 102, 104, 106 may be varied to increase or reduce the overlap of the coverage areas 114, 116, 118.

In the event of an emergency, the mobile device 120 may initiate a connection to the responding agency 122 via a communication network. The communication network may include a wide variety of communication equipment such as, for example, one or more base stations 126 that communicate with the mobile device 120 via the longer-range wireless link 124 and a call processing center or unit 128 to manage and direct communication between the mobile station and the responding agency 122. The call processing unit 128 processes the connection and transfers emergency data from the mobile device 120 to the responding agency 122. The appropriate responding agency 122 for a local area that includes a particular beacon 104 is one that corresponds to the contact information provided by the beacon signal of the particular beacon.

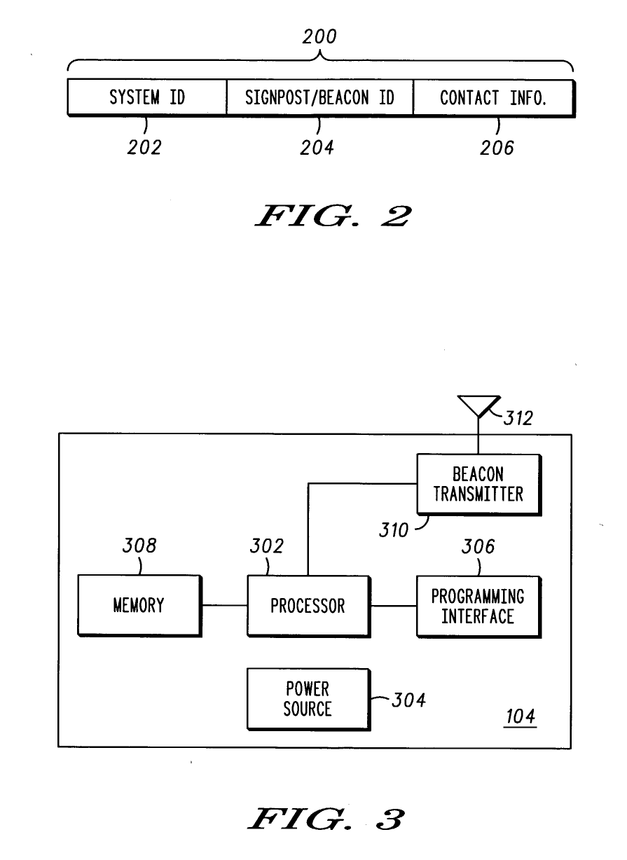

Referring to FIG. 2, the contents of a beacon signal 200 are represented. For the preferred embodiment, the contents of the beacon signal 200 may include, but is not limited to, a system identification (“system ID”) 202, a signpost or beacon identification (“unit ID”) 204 and contact information 206 corresponding a responding agency. The system ID 202 identifies the general system in which the beacon operates, and the unit ID 204 identifies a specific signpost or beacon within that system. The contact information 208 may include one or more contact addresses, such as a telephone number, a uniform resource locator (“URL”), an Internet Protocol (“IP”) address or another form of electronic addressing, that may be used to connect with the appropriate responding agency. Additional and/or alternative information includes, but is not limited to, supplemental contact information that may be referenced if the original contact information does not lead to a satisfactory result and information that provides the location of the beacon, such as latitude/longitude coordinates.

FIG. 3 is a block diagram representing a beacon 104 (as well as beacons 102 and 104). The beacon 104 includes a processor 302 that interacts with the other major functional components and a power source 304 that provides electrical power these components. When the beacon 104 is in a programming state before operation, the processor 302 receives input from a programming interface 306 in which system parameters are sent to the processor. The processor 302 receives the system parameters from the programming interface 306 and stores them in a memory circuit 308. The system parameters include the contents of the beacon signal 200, i.e., the system ID 202, unit ID 204 and contact information 206, shown in FIG. 2. Thus, the beacon 104 may be programmed with the contents of the beacon signal 200 via the programming interface 306 under the control of the processor 302.

When placed in an operational state after being programmed, the processor 302 retrieves the system parameters from the memory circuit 308, formats the system parameters as required and forwards them to a beacon transmitter 310. The beacon transmitter 310 broadcasts the system parameters, continuously or at intervals, in the form of the beacon signal 200 over it corresponding coverage area 116. For the preferred embodiment, the broadcast signal is radio frequency energy transmitted via an antenna 312, but it is to be understood that the broadcast signal may be any form of wireless communication, such as infrared or ultrasonic.

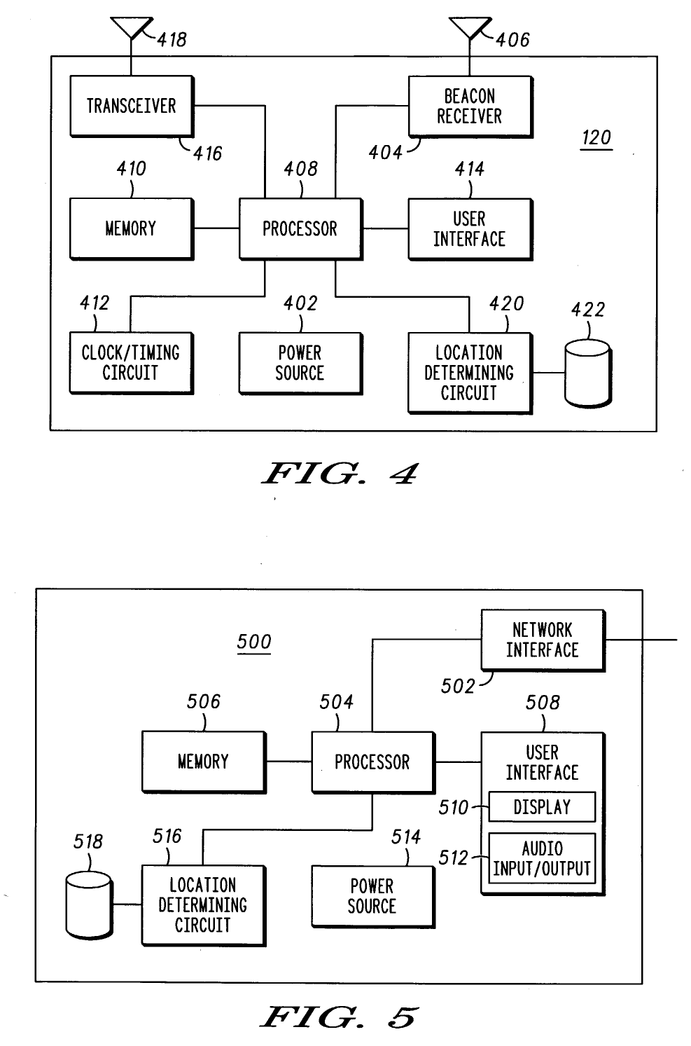

FIG. 4 is a block diagram of the mobile device 120 that includes and a power source 402 to provide electrical power the internal components of the device. The internal components include circuitry to receive and process the contents of the beacon signal 200. In particular, the beacon signal 200 is received and demodulated by the beacon receiver 404. For the preferred embodiment, the beacon signal is radio frequency energy received via an antenna 406. The decoded beacon data is passed to a processor 408, which compares the data with previously received data, if any, stored in a memory circuit 410. If the beacon data has changed, the new beacon data is stored in the memory circuit 410 to replace or supplement the old beacon data. A timestamp, generated by a clock/timing circuit 412, may also be stored with the beacon data.

The mobile device 120 further includes a user interface 414 and a transceiver circuit 416 coupled to the processor 408. When a user of the mobile device 120 desires to make an emergency call, the user may access the user interface 414. For the preferred embodiment, the user interface 414 includes a contact sensor configured to detect a user activation, but it is to be understood that other types of sensors may be used such as a motion detector or an audio microphone. In response to the user activation, the processor 408 retrieves the current beacon data from the memory circuit 410, makes a connection to a responding agency 122 via the transceiver circuit 416 and the communication network 126, 128, and forwards at least a portion of the beacon data to the responding agency. For the preferred embodiment, the transceiver circuit 416 communicates with a base station 126 via an antenna 418. The connection to the responding agency 122 is accomplished directing the communication to a contact address identified by the contact information 206 of the beacon signal 200. In an alternate embodiment, an additional call from the mobile device 120 to a standard emergency number, such as 911 or 112, may be placed adjacent to the call to the indicated responding agency 122.

The information provided to the responding agency 122 includes the system ID 202 and the unit ID 204 of the beacon 104. Based on this information, the responding agency 122 may determine the location of the beacon 104 and, thus, the mobile device 120 located near the beacon 104. In addition, the mobile device 120 also provides a caller identification and/or caller name associated with the mobile device along with the location-related information. The caller identification or name may be provided by the mobile station 120 or provided by the communication network, e.g., the call processing unit 128, with the location-related information or separately.

For the preferred embodiment, the contact information includes a telephone number of the responding agency 122 so that the mobile device 120 may place a call to the telephone number. In the alternative, the contact information may include a URL associated with an Internet web address so that the mobile device 120 may establish a data connection with the server addressed by the URL. In yet another alternative, thee contact information may include an Internet Protocol (IP) address associated with an Internet server address so that the mobile device 120 may establish a data connection with the server addressed by the IP address.

The mobile device 120 may include a location determining circuit 420 and a database 422 correlating system ID's 202 and unit ID's 204 with a location of the beacon 104. For example, by looking-up a particular set of system ID's 202 and unit ID's 204 in the database 422, the location determining circuit 420 may determine the location coordinates of the corresponding beacon 104 so that these location coordinates may be communicated to the responding agency 122 via the transceiver circuit 416. As another alternative, the beacon receiver 404 may simply receive the location information from the beacon 104 if the beacon stores such information in its memory circuit 308 and transmits it via the beacon transmitter 310. The beacon data transmitted by the transceiver circuit 416 may optionally include a timestamp generated by the clock/timing circuit 412 which corresponds to the last beacon signal received to assist the responding agency 122 in determining whether the information is up-to-date.

The mobile device 120 may move between areas covered by different beacons. When moving from area to area, the mobile device 120 may receive and decode location and contact information after detecting an activation of an emergency condition. The mobile device may also receive and store location and contact information in the memory circuit 410 on a periodic basis and, in response to an activation of an emergency condition, retrieve the information from the memory circuit. The latter case, a current timestamp may be stored with the location and contact information. The mobile device 120 may compare received beacon data to beacon data stored in the memory circuit 410. If the beacon data is the same, then only the timestamp needs to be updated. If the beacon data is different, then the new beacon data and the current timestamp may be written to the memory circuit 410. In the alternative, the beacon information does not need to include a timestamp. In such case, the latest received beacon data can be marked obsolete or deleted from the memory circuit 410 if it is not updated within a predetermined period of time such as, for example, 10 minutes.

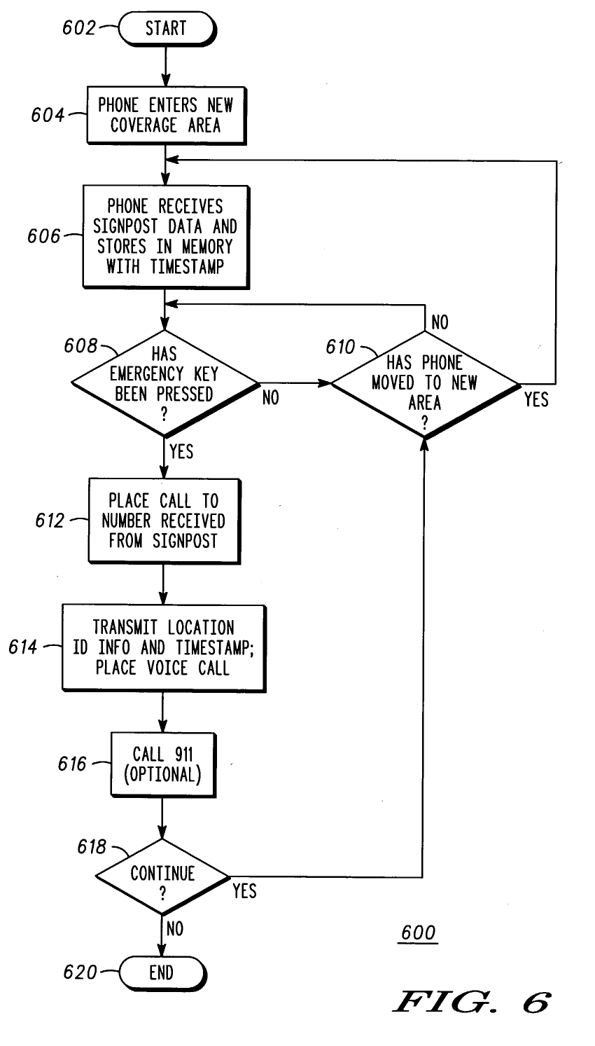

FIG. 5 is a block diagram representing an exemplary answering point system 500 of the responding agency 122. A transmission from the mobile device 120 may be processed by the call processing unit 128, which forwards the transmission to a network interface 502 of the answering point system 500. The answering point system 500 also includes a processor 504 to manage primary functions of the system, a memory circuit 506 to store relevant call information, and a user interface 508 for interaction by personnel located at the responding agency 122. The user interface 508 may include one or more displays 510 as well as one or more audio input/out devices 512. For example, if voice data is available as part of an incoming call, such data is forwarded to the audio input/output devices 512, such as an earpiece and microphone headset, for audible communication with the mobile device 120. The answering point system 500 further includes a power source 514 to provide power to the various components of the system.

The responding agency 122, particularly its answering point system 500, may received various information from the beacon 104 and/or the mobile device 120, such as the system ID 202 and the unit ID 204 of the beacon. Based on this information, the responding agency 122 may determine the location of the beacon 104 and, thus, the mobile device 120 located near the beacon. Accordingly, the answering point system 500 may further include a location determining circuit 516 and a database 518 correlating system ID's 202 and unit ID's 204 with a location of the beacon 104. In the alternative, as described above, the beacon 104 and/or the mobile device 120 may provide the location of the beacon to the answering point system 500. By looking-up a particular set of system ID's 202 and unit ID's 204 in the database 518, the location determining circuit 516 may determine the location coordinates of the corresponding beacon 104 so that these location coordinates may be provided to personnel of the responding agency 122 via the user interface 508, such as the display 510.

The display 510, as well as any other component of the user interface 508, may provide a wide variety of information that may be useful to the personnel of the responding agency 122. Examples of such information include, but are not limited to, caller identification and/or name associated with the mobile device 120, subscriber profile information associated with the mobile device 120, system ID's and unit ID's associated with the beacon 104, and location coordinates and maps corresponding to the location of the beacon. The caller identification or name may be provided by the mobile station 120 or provided by the communication network, e.g., the call processing unit 128.

When emergency information is received by the responding agency 122, the information is directed to the answering point system 500. The processor 504 of the answering point system 500 decodes and stores the received information in the memory circuit 506. The processor 504 also displays the information on the display 510. Also, the display 510 may also display a map of the vicinity showing the location of the beacon 104 or adjacent mobile device 120. If voice data is present in the information from the mobile station 120, it may be directed by the processor 504 to voice circuitry of the user interface 508 and further to an audio input/output device 512, such as a headset.

Referring to FIG. 6, there is provided a flow diagram representing a preferred operation 600 of the mobile device 120. Starting at step 602, the mobile device 120 enters an initial coverage area at step 604. In particular, the processor 408 of the mobile device 120 monitors the incoming signals received by the beacon receiver 404 for a beacon signal transmitted by a particular beacon 102, 104, 106. The processor 408 then identifies signpost or beacon data received by the beacon receiver 404 and stores the received data in the memory circuit 410 along with a timestamp at step 606. Thereafter, the processor 408 monitors its user interface 414 for any activation of an emergency condition, e.g., selection of an emergency key, at step 608 and continues to monitor the incoming signals received by the beacon receiver 404 to determine whether the mobile device 120 has moved to a new coverage area at step 610. If activation of an emergency condition or movement to a new coverage area has not occurred, the mobile device 120 simply continues to monitor conditions at steps 608 and 610. If activation of an emergency condition has not occurred but the mobile device 120 has moved to a new coverage area, then the mobile device stores the new signpost or beacon data and timestamp in the memory circuit 410 at step 606 and continues to monitor conditions at steps 608 and 610.

If activation of an emergency condition has occurred, then the mobile station 120 initiates a voice and/or data connection based the contact information 206 received by the beacon receiver 404 or most recently stored in the memory circuit 410 at step 612. The processor 408 then transmits the system ID 202, the unit ID 204, timestamp and/or other location information of the beacon 102, 104, 106, to the answering point system 500 of the responding agency 122 at step 614. Also, at step 614, the mobile device 120 may place a voice call to the answering point system 500 of the responding agency 122. At step 616, the mobile device 120 may optionally place an additional call to a standard emergency number, such as 911 or 112, adjacent to the call to the responding agency 122. Thereafter, the mobile device 120 may determine whether to continue its current operation at step 618. If the mobile device 120 decides to continue its current operation, then the mobile device continues to monitor conditions at steps 608 and 610. Otherwise, if the mobile device 120 does not decide to continue its current operation, then the preferred operation of the mobile device terminates at step 620.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device for communicating emergency information to a local responding agency comprising:
a receiving circuit configured to receive location information and contact information from a beacon, the location information corresponding to a location of the beacon; and
a processor, coupled to the receiving circuit, configured to identify a communication node of the local responding agency based the contact information and connecting to the communication node in response to detecting a user activation.

2. The wireless communication device of claim 1, wherein the receiving circuit receives updated location information from a second beacon in response to a change in location by the wireless communication device.

3. The wireless communication device of claim 1, wherein the contact information is one of a telephone number and a network address.

4. The wireless communication device of claim 3, wherein the network address is a uniform resource locator.

5. The wireless communication device of claim 1, wherein the contact information is associated with a responding agency that provides emergency services within the location of the beacon.

6. The wireless communication device of claim 1, further comprising a transceiver configured to transmit the call to a wireless base station of a telecommunications network.

7. The wireless communication device of claim 1, further comprising a user interface configured to detect the user activation.

8. The wireless communication device of claim 4, wherein the user interface is one of either a contact sensor, a motion detector and an audio microphone.

9. An apparatus for assisting a wireless communication device to communicate emergency information to a local responding agency comprising:
a beacon, located within a local area, operable to transmit location information corresponding to the local area and contact information associated with the local responding agency.

10. The apparatus of claim 9, wherein the location information corresponds to an identification of the beacon.

11. The apparatus of claim 10, wherein the local responding agency correlates the identification of the beacon with a location coordinate of the beacon.

12. The apparatus of claim 9, further comprising a second beacon configured to provide updated location information in response to a change in location by a remote device.

13. The apparatus of claim 12, wherein the second beacon is in wireless communication with the remote device and detects the change in location by the remote device.

14. The apparatus of claim 9, wherein the contact information is one of a telephone number and a network address.

15. The apparatus of claim 9, wherein the network address is a uniform resource locator.

16. The apparatus of claim 9, wherein the contact information is associated with a responding agency that provides emergency services within the local area.
